(19) United States
(12) Patent Application Publication
(10) Pub. No.: US 2026/0238563 A1
(43) Pub. Date: Aug. 13, 2026

(54) TERMINAL DEVICE, NETWORK DEVICE, AND METHOD FOR AI MODEL TRANSFER

(71) Applicant: Lenovo (Beijing) Limited, Beijing (CN)

(72) Inventors: Lizhuo Zheng, Shanghai (CN); Congchi Zhang, Shanghai (CN); Jianfeng Wang, Beijing (CN); Mingzeng Dai, Shanghai (CN); Shuigen Yang, Shanghai (CN); Bingchao Liu, Beijing (CN)

(73) Assignee: Lenovo (Beijing) Limited, Beijing (CN)

(21) Appl. No.: 19/475,183

(22) PCT Filed: Apr. 14, 2023
(86) PCT No.: PCT/CN2023/088496

§ 371 Date: Oct. 14, 2025

(51) Int. Cl. H04L 41/16

(52) U.S. Cl. CPC H04L 41/16

(57) ABSTRACT

Embodiments of the present disclosure relate to a solution for AI model transfer. In one aspect of the solution, the terminal device keeps part of an AI model that has been successfully received at the terminal device if an interruption occurs during a reception of the AI model. Upon the interruption has been recovered, the terminal device transmits, to a first network device, a status message indicating the part of the AI model for the first network device to decide handling of the part of the AI model at the terminal device. In some embodiments, the first network device may transfer a remaining part of the AI model instead of providing the whole of the AI model. Therefore, the transmission efficiency may be improved and the air interface resources may be used in a more efficient way.

### FIELD

Embodiments of the present disclosure generally relate to the field of communication, and in particular to a terminal device, a network device, and a method for artificial intelligence (AI) model transfer.

### BACKGROUND

AI model may be obtained by machine learning (ML) or deep learning (DL), and has been widely used in a variety of application areas. For example, a study item (SI) has been proposed in the third generation partnership project (3GPP) to introduce the AI model into air interface.

In some cases, part or all of an inference by using an AI model may be performed at a terminal device, such as user equipment (UE). In this event, how to transfer the AI model to the UE via an air interface should be further studied.

### SUMMARY

In general, embodiments of the present disclosure provide a solution for transferring an AI model.

In a first aspect, there is provided a terminal device. The terminal device comprises a processor and a transceiver coupled to the processor, wherein the processor is configured to: based on a determination that an interruption occurs during a reception of an artificial intelligence (AI) model, keeping part of the AI model that has been successfully received at the terminal device; and based on a determination that the interruption has been recovered, transmit, via the transceiver, to a first network device, a status message indicating the part of the AI model for the first network device to decide handling of the part of the AI model at the terminal device.

In a second aspect, there is provided a first network device. The first network device comprises a processor and a transceiver coupled to the processor, wherein the processor is configured to: receive, via the transceiver, from a terminal device, a status message indicating part of an AI model which has been kept at the terminal device before an interruption occurs; and determine a handing manner of the part of the AI model at the terminal device.

In a third aspect, there is provided a second network device. The second network device comprises a processor and a transceiver coupled to the processor, wherein the processor is configured to: transmit, via the transceiver, to a terminal device, one or more messages comprising one or more segments of an AI model and information of the AI model comprising an identifier (ID) of the AI model, wherein the information of the AI model further comprises at least one of: a total number of segments, a start marker, or an end marker.

In a fourth aspect, there is provided a method performed by a terminal device. The method comprises: based on a determination that an interruption occurs during a reception of an AI model, keeping part of the AI model that has been successfully received at the terminal device; and based on a determination that the interruption has been recovered, transmitting, to a first network device, a status message indicating the part of the AI model for the first network device to decide handling of the part of the AI model at the terminal device.

In a fifth aspect, there is provided a method performed by a first network device. The method comprises: receiving, from a terminal device, a status message indicating part of an AI model which has been kept at the terminal device before an interruption occurs; and determining a handing manner of the part of the AI model at the terminal device.

In a sixth aspect, there is provided a method performed by a second network device. The method comprises: transmitting, to a terminal device, one or more messages comprising one or more segments of the AI model and information of the AI model comprising an ID of the AI model, wherein the information of the AI model further comprises at least one of: a total number of segments, a start marker, or an end marker.

In a seventh aspect, there is provided a computer readable medium. The computer readable medium has instructions stored thereon. The instructions, when executed on at least one processor of a device, causing the device to perform the method of any of the fourth to the sixth aspects.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings, in which:

FIG. 1 illustrates a schematic diagram of a communication environment in which some embodiments of the present disclosure can be implemented;

FIG. 2A illustrates an example of a process flow for a radio link failure recovery in accordance with some example embodiments of the present disclosure;

FIG. 2B illustrates an example of a process flow for a radio link failure recovery in accordance with some example embodiments of the present disclosure;

FIG. 3A illustrates an example of a process flow for a handover in accordance with some example embodiments of the present disclosure;

FIG. 3B illustrates an example of a process flow for a handover in accordance with some example embodiments of the present disclosure;

FIG. 4 illustrates an example of a process flow in accordance with some example embodiments of the present disclosure;

FIG. 5 illustrates an example of a segmentation of an AI model in accordance with some example embodiments of the present disclosure;

FIG. 6 illustrates an example of process at a terminal device in accordance with some example embodiments of the present disclosure;

FIG. 7A illustrates an example of a process flow in accordance with some example embodiments of the present disclosure;

FIG. 7B illustrates another example of a process flow in accordance with some example embodiments of the present disclosure;

FIG. 8A illustrates an example of a process flow in accordance with some example embodiments of the present disclosure;

FIG. 8B illustrates another example of a process flow in accordance with some example embodiments of the present disclosure;

FIG. 9 illustrates a flowchart of an example method performed by a terminal device in accordance with some embodiments of the present disclosure;

FIG. 10 illustrates a flowchart of an example method performed by a first network device in accordance with some embodiments of the present disclosure;

FIG. 11 illustrates a flowchart of an example method performed by a second network device in accordance with some embodiments of the present disclosure; and

FIG. 12 illustrates a simplified block diagram of an apparatus that is suitable for implementing embodiments of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below. In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms. In some examples, values, procedures, or apparatuses are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

The terminology used herein is for the purpose of describing particular embodiments only and is not intended to be limiting of embodiments. As used herein, the singular forms “a,” “an” and “the” are intended to include the plural forms as well, unless the context clearly indicates otherwise. It will be further understood that the terms “comprises,” “comprising,” “has,” “having,” “includes” and/or “including,” when used herein, specify the presence of stated features, elements, components and/or the like, but do not preclude the presence or addition of one or more other features, elements, components and/or combinations thereof. For example, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The use of an expression such as “A and/or B” can mean either “only A” or “only B” or “both A and B.” Other definitions, explicit and implicit, may be included below.

As used herein, the term “communication network” refers to a network following any suitable communication standards, such as, 5G NR, Long Term Evolution (LTE), LTE-Advanced (LTE-A), Wideband Code Division Multiple Access (WCDMA), High-Speed Packet Access (HSPA), Narrow Band Internet of Things (NB-IoT), and so on. Further, the communications between a terminal device and a network device in the communication network may be performed according to any suitable generation communication protocols, including but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication network via which a terminal device can access the communication network and receive services therefrom. The network device may refer to an access network device, such as a base station (BS) or an access point (AP), for example, a node B (NodeB or NB), a radio access network (RAN) node, an evolved NodeB (eNodeB or eNB), a NR NB (also referred to as a gNB), a Remote Radio Unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology. The network device may refer to a core network device, such as an Access and Mobility Management Function (AMF), a Location Management Function (LMF), Network Data Analytics Function (NWDAF), and so forth.

As used herein, the term “terminal device” generally refers to any end device that may be capable of wireless communications. By way of example rather than a limitation, a terminal device may also be referred to as a communication device, a user equipment (UE), an end user device, a subscriber station (SS), an unmanned aerial vehicle (UAV), a portable subscriber station, a mobile station (MS), or an access terminal (AT). The terminal device may include, but is not limited to, a mobile phone, a cellular phone, a smart phone, a voice over IP (VOIP) phone, a wireless local loop phone, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an Internet of Things (IoT) device, a watch or other wearable, a head-mounted display (HMD), a vehicle, a drone, a medical device (for example, a remote surgery device), an industrial device (for example, a robot and/or other wireless devices operating in an industrial and/or an automated processing chain contexts), a consumer electronics device, a device operating on commercial and/or industrial wireless networks, and the like. In the following description, the terms: “terminal device,” “communication device,” “terminal,” “user equipment” and “UE,” may be used interchangeably.

As used herein, the term: “resource,” “transmission resource,” “resource block,” “physical resource block,” “uplink resource,” “downlink resource,” or “sidelink resource” may refer to any resource, for example a resource in time domain, a resource in frequency domain, a resource in space domain, a resource in code domain, or any other resource enabling a communication, and the like, used for performing a communication between a terminal device and a network device or between terminal devices. In the following, a resource in both frequency and time domain will be used as an example of a transmission resource for describing some embodiments of the present disclosure. It is noted that embodiments of the present disclosure equally apply to other resources in other domains.

In the present disclosure, an AI model may also be referred to as an ML model, a DL model, or the like, the present disclosure does not limit this aspect.

AI/ML is used to learn and perform certain tasks via training neural networks with vast amounts of data, which is successfully applied in computer vison (CV) and nature language processing (NLP) areas. As a subset of ML, DL utilizes multi-layered neural networks (NN) as the “AI model” to learn solving problems and optimize performance from vast amounts of data. Because of the promising benefits presented in many academic papers and field test results, the AI/ML-based methods can obtain a better performance compared to the traditional one if well trained.

Thus, 3GPP is discussing to introduce AI/ML into air interface and the relevant objectives of the study item (SI) in the study item description (SID) are shown below:

...

| | |
|---|---|
| 1) | Assess potential specification impact, specifically for the agreed use cases in the final |
| | representative set and for a common framework: |

| | |
|---|---|
| ∘ | PHY layer aspects, e.g., (RAN1) |

| | |
|---|---|
| ▪ | Consider aspects related to, e.g., the potential specification of the AI Model |
| | lifecycle management, and dataset construction for training, validation and test |
| | for the selected use cases |
| ▪ | Use case and collaboration level specific specification impact, such as new |
| | signalling, means for training and validation data assistance, assistance |
| | information, measurement, and feedback |

| | |
|---|---|
| ∘ | Protocol aspects, e.g., (RAN2) - RAN2 only starts the work after there is sufficient |
| | progress on the use case study in RAN1 |

| | |
|---|---|
| ▪ | Consider aspects related to, e.g., capability indication, configuration and |

| | |
|---|---|
| | control procedures (training/inference), and management of data and AI/ML |
| | model, per RAN1 input |
| ▪ | Collaboration level specific specification impact per use case |

...

| 2) | Study the 3GPP framework for AI/ML for air-interface corresponding to each target use | |
|---|---|---|
| | case regarding aspects such as performance, complexity, and potential specification | |
| | impact. | |
| | Use cases to focus on: | |
| - | | Initial set of use cases includes: |

| | |
|---|---|
| ∘ | CSI feedback enhancement, e.g., overhead reduction, improved accuracy, |
| | prediction [RAN1] |
| ∘ | Beam management, e.g., beam prediction in time, and/or spatial domain for |
| | overhead and latency reduction, beam selection accuracy improvement [RAN1] |
| ∘ | Positioning accuracy enhancements for different scenarios including, e.g., those |
| | with heavy NLOS conditions [RAN1] |

In some cases, (at least part of) the AI inference is performed at UE side. Such UE-sided AI model could be trained by the 3GPP network or an external application server, and then be transferred from the network (e.g., gNB and a core network device (NWDAF/AMF/LMF)) to UE via the air interface. Therefore, the transfer process through air interface is quite essential to make sure the AI models are successfully delivered. However, the air interface link could be very vulnerable due to the time-varying channel condition and the mobility of the UE. The link quality may get very poor because of the link degradation and change, which may lead to the AI model transfer interruption. Certain measures to resume the transfer in case of AI model transfer interruption could be beneficial, especially because the size of AI model could be up to >100 MB and it is not efficient to transmit from zero again.

When an interruption happens, the on-going AI model transfer is suspended, UE is unable to continue receiving the AI model from the network device, and the network device may be also unable to tell whether the AI model is successfully delivered or not (e.g., when UE reconnects to a different gNB or handed over to a different gNB), posing severe damage to the application of AI model at UE. However, so far, there are no relevant discussions or existing procedures on how to address the AI model transfer interruption.

Embodiments of the present disclosure provide a solution for transferring the AI model to a terminal device. In case an interruption occurs during a transmission of an AI model, the terminal device may transmit a status message to the network device when the interruption recovers. As such, the network device may transfer a remaining part of the AI model instead of providing the whole of the AI model. Therefore, the transmission efficiency may be improved and the air interface resources may be used in a more efficient way.

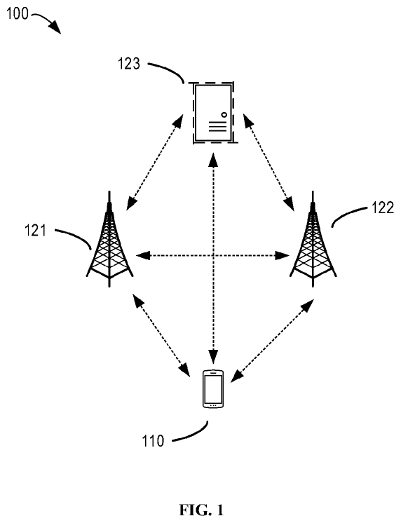

FIG. 1 illustrates a schematic diagram of a communication environment 100 in which some embodiments of the present disclosure can be implemented. As shown in FIG. 1, the communication environment 100, which may also be referred to as a communication network 100 or a communication system 100, includes a terminal device 110, a network device 121, a network device 122, and a network device 123. The network device 121 or 122 may serve the terminal device 110 as shown in FIG. 1, but it is to be understood that the network device 121 or 122 may also serve one or more other terminal devices, which will be discussed herein.

The network device 121 and the network device 122 may be access network devices, such as an eNB, a gNB, an ng-eNB, etc. The network device 123 may be a core network (CN) device, such as an LMF, an AMF, an NWDAF, etc.

In particular, as illustrated in the exemplary scenario of FIG. 1, the terminal device 110 may communicate with the network device 121 via a communication link, such as a Uu link. For transmissions from the network device 121 to the terminal device 110, the communication link may be referred to as a downlink (DL), whereas for transmissions from the terminal device 110 to the network device 121, the communication link may alternatively be referred to as an uplink (UL).

In some other examples, the terminal device 110 may communicate with the network device 122 via a communication link, such as a Uu link. In some embodiments, the network device 122 may be absent in the communication environment 100.

Although the network device 121/122/123 and the terminal device 110 are described in the communication environment 100 of FIG. 1, embodiments of the present disclosure may equally apply to any other suitable communication devices in communication with one another. That is, embodiments of the present disclosure are not limited to the exemplary scenarios of FIG. 1. In this regard, it is noted that although the network device 121/122 is schematically depicted as a base station and the terminal device 110 is schematically depicted as mobile phones in FIG. 1, it is understood that these depictions are exemplary in nature without suggesting any limitation. In other embodiments, the network devices 121-123 and the terminal device 110 may be any other communication devices, for example, any other wireless communication devices.

It is to be understood that the particular number of various communication devices, the particular number of various communication links, and the particular number of other elements as shown in FIG. 1 is for illustration purpose only without suggesting any limitations. The communication environment 100 may include any suitable number of communication devices, any suitable number of communication links, and any suitable number of other elements adapted for implementing embodiments of the present disclosure. In addition, it should be appreciated that there may be various wireless as well as wireline communications (if needed) among all of the communication devices.

Communication in the communication environment 100 may be implemented according to any proper communication protocol(s), comprising but not limited to, cellular communication protocols of the first generation (1G), the second generation (2G), the third generation (3G), the fourth generation (4G) and the fifth generation (5G), NR-U and the like, wireless local network communication protocols such as Institute for Electrical and Electronics Engineers (IEEE) 802.11 and the like, and/or any other protocols currently known or to be developed in the future. Moreover, such communication may utilize any appropriate wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

As mentioned above, part of the AI inference may be performed at a terminal device, and thus the AI model should be transferred to the terminal device from a network side. A size of an AI model could be range from Kilobytes to Megabytes level, and it is transmitted using any approach, depending on the scenarios, based on the following:
Solution 1a: gNB can transfer/deliver AI/ML model(s) to UE via RRC signalling.
Solution 2a: CN (except LMF) can transfer/deliver AI/ML model(s) to UE via NAS signalling.
Solution 3a: LMF can transfer/deliver AI/ML model(s) to UE via LPP signalling.
Solution 1b: gNB can transfer/deliver AI/ML model(s) to UE via UP data.
Solution 2b: CN (except LMF) can transfer/deliver AI/ML model(s) to UE via UP data.
Solution 3b: LMF can transfer/deliver AI/ML model(s) to UE via UP data.
Solution 4: Server (e.g. OAM, OTT) can transfer/delivery AI/ML model(s) to UE (e.g. transparent to 3GPP).

The mapping between above solutions and applicable use cases is shown in Table 1 below:

TABLE 1

| SOLUTIONS | APPLICABLE USE CASES |
|---|---|
| Solution 1a, 1b | CSI feedback enhancement |
| | Beam management |
| | Note: No specific considerations for Positioning accuracy |
| | enhancement for Solutions 1a and 1b. |
| Solution 2a, 2b | CSI feedback enhancement |
| | Beam management |
| | Note: No specific considerations for Positioning accuracy |
| | enhancement for Solutions 2a and 2b. |
| Solution 3a, 3b | Positioning accuracy enhancement |
| Solution 4 | CSI feedback enhancement |
| | Beam management |
| | Positioning accuracy enhancement |

With reference to FIG. 1, the network device 121/122 or the network device 123 may transmit the AI model to the terminal device 110. It is to be understood that the term “transmit” in the present disclosure may also be referred to as “transfer”, “deliver”, “provide”, or the like. It is to be understood that the AI model transmission in the present disclosure may be applied to control plane (CP) or user plane (UP).

In the present disclosure, the term “kept” may also be referred to as “buffered” or “stored” or the like.

During a transmission of the AI model, an interruption may occur. For example, the interruption may include a radio link failure (RLF) or a handover.

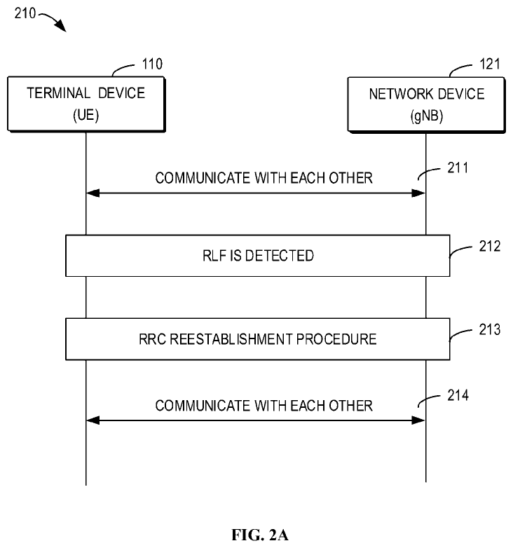

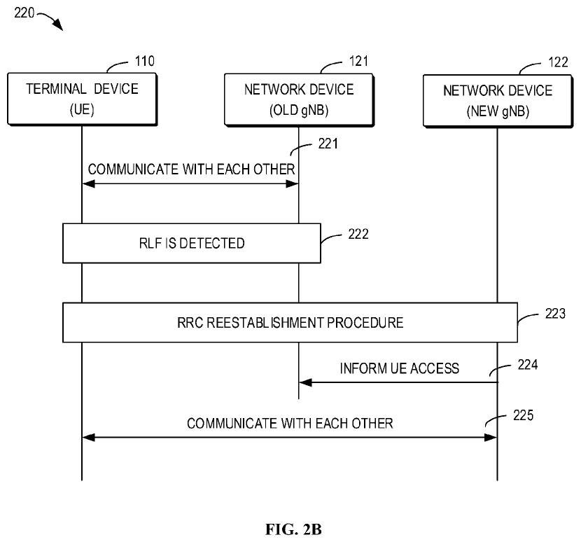

FIG. 2A illustrates an example of a process flow 210 for a radio link failure (RLF) recovery in accordance with some example embodiments of the present disclosure. The process flow 210 involves the terminal device 110 and the network device 121 as shown in FIG. 1. For example, the terminal device 110 may be a UE and the network device 121 may be a gNB. Although the process flow is described with reference to FIG. 1, it would be appreciated that the process flow 210 may be applied to other communication scenarios.

It is assumed that the terminal device 110 is located in coverage of the network device 121 initially, in other words, the network device 121 serves the terminal device 110. For example, the terminal device 110 may communicate with the network device 121 at 211.

At 212, a radio link failure may be detected. For example, a quality of the link between the terminal device 110 and the network device 121 is lower than a threshold.

At 213, a radio resource control (RRC) reestablishment procedure is performed. In some examples, the terminal device 110 may initiate the RRC reestablishment procedure and reestablish the RRC connection with the network device 121. In other words, a same network device (i.e., the network device 121) serves the terminal device 110 before and after the RLF. In other words, the RLF is recovered in an intra-gNB situation. Accordingly, the terminal device 110 may continue communicating with the network device 121 at 214.

FIG. 2B illustrates an example of a process flow 220 for a radio link failure (RLF) recovery in accordance with some example embodiments of the present disclosure. The process flow 220 involves the terminal device 110, the network device 121, and the network device 122 as shown in FIG. 1. For example, the terminal device 110 may be a UE, the network device 121 may be an old gNB, and the network device 122 may be a new gNB. Although the process flow is described with reference to FIG. 1, it would be appreciated that the process flow 220 may be applied to other communication scenarios.

It is assumed that the terminal device 110 is located in coverage of the network device 121 initially, in other words, the network device 121 serves the terminal device 110. For example, the terminal device 110 may communicate with the network device 121 at 221.

At 222, a radio link failure may be detected. For example, a quality of the link between the terminal device 110 and the network device 121 is lower than a threshold.

At 223, an RRC reestablishment procedure is performed. In some examples, the terminal device 110 may initiate the RRC reestablishment procedure and reestablish the RRC connection with the network device 122. The network device 122 may further inform the network device 121 about the terminal device 110's access at 224.

In other words, different network devices serve the terminal device 110 before and after the RLF. For example, the network device 121 may be referred to as an old gNB and the network device 122 may be referred to as a new gNB. In other words, the RLF is recovered in an inter-gNB situation. Accordingly, the terminal device 110 may communicate with the network device 122 at 225.

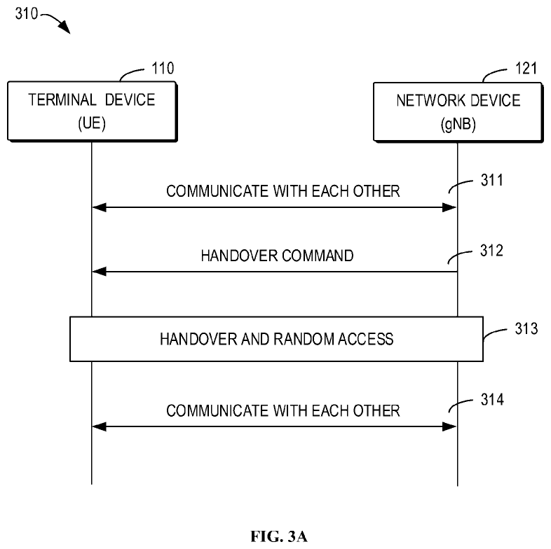

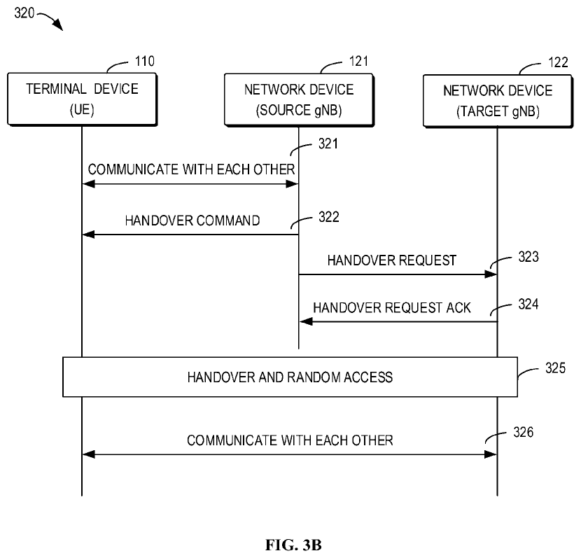

FIG. 3A illustrates an example of a process flow 310 for a handover (HO) in accordance with some example embodiments of the present disclosure. The process flow 310 involves the terminal device 110 and the network device 121 as shown in FIG. 1. For example, the terminal device 110 may be a UE and the network device 121 may be a gNB. Although the process flow is described with reference to FIG. 1, it would be appreciated that the process flow 310 may be applied to other communication scenarios.

It is assumed that the terminal device 110 is located in coverage of the network device 121 initially, in other words, the network device 121 serves the terminal device 110. For example, the terminal device 110 may communicate with the network device 121 at 311.

At 312, the network device 121 transmits a handover command to the terminal device 110. In some examples, the handover command may be transmitted via an RRC message.

At 313, the terminal device 110 may be handed over to a new cell of the network device 121 and may perform a random access procedure. In other words, the terminal device 110 is handed over from an old cell to a new cell of a same network device 121, the network device 121 may be both the source and target gNB for the handover. In other words, the handover is performed in an intra-gNB situation. Accordingly, the terminal device 110 may continue communicating with the network device 121 at 314.

FIG. 3B illustrates an example of a process flow 320 for a handover in accordance with some example embodiments of the present disclosure. The process flow 320 involves the terminal device 110, the network device 121, and the network device 122 as shown in FIG. 1. For example, the terminal device 110 may be a UE, the network device 121 may be a source gNB, and the network device 122 may be a target gNB. Although the process flow is described with reference to FIG. 1, it would be appreciated that the process flow 320 may be applied to other communication scenarios.

It is assumed that the terminal device 110 is located in coverage of the network device 121 initially, in other words, the network device 121 serves the terminal device 110. For example, the terminal device 110 may communicate with the network device 121 at 321.

At 322, the network device 121 transmits a handover command to the terminal device 110. In some examples, the handover command may be transmitted via an RRC message.

At 323, the network device 121 transmits a handover request to the network device 122, where the handover request may ask for a handover of the terminal device 110. For example, the network device 121 may be referred to as a source gNB and the network device 122 may be referred to as a target gNB. At 324, the network device 122 replies with a handover request acknowledge (ACK) to the network device 121. It is to be understood that the handover request and the handover request ACK may be transmitted via an Xn interface. It is to be noted that the step 322 may be performed after the step 324, the illustration in FIG. 3B is shown without any limitation.

At 325, the terminal device 110 may be handed over to the network device 122 and may perform a random access procedure. In other words, the terminal device 110 is handed over from a cell of the network device 121 to another cell of the network device 122, e.g., the terminal device 110 is accessed to a new gNB. In other words, the handover is performed in an inter-gNB situation. Accordingly, the terminal device 110 may continue communicating with the network device 122 at 326.

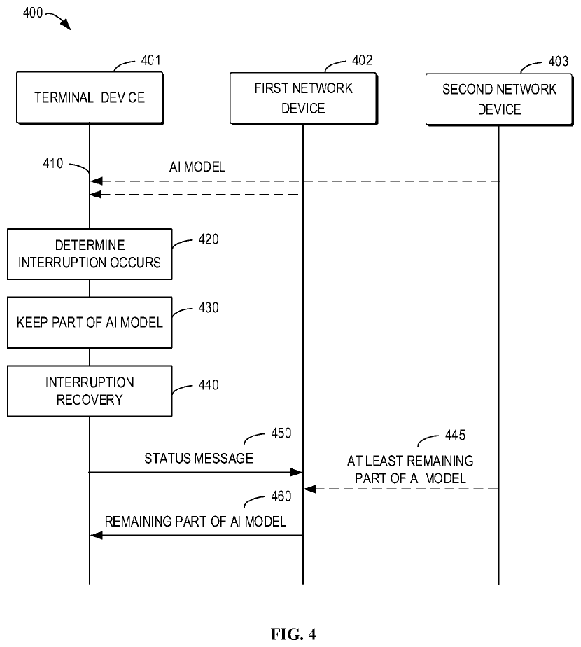

FIG. 4 illustrates an example of a process flow 400 in accordance with some example embodiments of the present disclosure. The process flow 400 involves a terminal device 401, a first network device 402, and a second network device 403. For the purpose of discussion, the terminal device 401 may be the terminal device 110, the first network device 402 may be any of the network devices 121-123, and the second network device 403 may be the network device 121, as shown in FIG. 1. The second network device 403 may be omitted in some cases. It would be appreciated that the process flow 400 may be applied to the network environment 100 of FIG. 1 or other communication scenarios.

As shown at 410, a reception of an AI model at the terminal device 401 is ongoing. In some example embodiments, a transmission of an AI model from the first network device 402 to the terminal device 401 is ongoing. In some other example embodiments, a transmission of an AI model from the second network device 403 to the terminal device 401 is ongoing. For ease of description, the first network device 402 or the second network device 403 which transmits the AI model at 410 may be called as a transmitter.

The AI model has been segmented into multiple segments (or multiple pieces, multiple sections, or the like). In some examples, the transmitter may segment the AI model based on one or more of: a transmission bandwidth, a channel condition, an emergency level of the AI model, etc. In some examples, the transmitter (i.e., the first network device 402 or the second network device 403) may transmit information of the AI model to the terminal device 401.

In one embodiment, the transmitter may transmit a model message to the terminal device 401, where the model message may include information of one or more AI models. Information of each AI model may include an identifier (ID) of the AI model, i.e., model ID. Different AI models may have different model IDs. In other words, the model ID may be model specific. It is to be understood that the model ID may be used for the terminal device and the network device to know which AI model is being transmitted currently.

In another embodiment, the information of the AI model may be transmitted at the beginning of the transmission of the AI model, for example, the information of the AI model may be transmitted before the first segment of the AI model or together with the first segment of the AI model.

The information of the AI model is different from the AI model, for ease of description, the information of the AI model may also be called as model related information, while the AI model may also be called as AI model payload (includes the AI structure and multiple model parameters) or AI model package.

In some examples, an ID of the AI model (model ID) may be used to identify the AI model. The information of the AI model may also include one or more of: a total number of segments, a start marker, an end marker, or a time limit of a timer.

In some examples, the total number of segments, the start marker, and the end marker may be called as model segmentation information. In some examples, the AI model may be segmented into multiple segments. Specifically, since the AI model may be with a large size and cannot be transmitted in one single packet, the AI model may be segmented into multiple smaller pieces, i.e., multiple segments. Each segment may be identified by and transmitted together with an index, where an index of a segment may also be called as a segment number (SN).

For example, if the total number of segments is N, the AI model payload is divided into N segments with indexes 1 to N. It is understood that each segment is associated with its index, i.e., a unique SN.

In some example embodiments, the information of the AI model may include an ID of the AI model, a total number of segments, and a start marker. In some other example embodiments, the information of the AI model may include an ID of the AI model, a total number of segments, and an end marker. In some other example embodiments, the information of the AI model may include an ID of the AI model, a total number of segments, a start marker, and an end marker.

Alternatively, the information of the AI model may further include a value for a timer, where the value may be a time limit of the timer. The timer may be also called as a model handling timer, which will be described below. In some examples, the value may be common for multiple AI models or may be a model-specific value. For example, the transmitter may determine whether the value is model specific based on the AI model and the use case.

In the process flow 400, as shown at 420, it is determined by the terminal device 401 that an interruption occurs during the reception of the AI model, e.g., from the first network device 402 to the terminal device 401 or from the second network device 403 to the terminal device 401.

In some example embodiments, the interruption may include an RLF or a handover. For example, the terminal device 401 may detect an RLF, and thus determines that the interruption occurs. For another example, the terminal device 401 may receive a handover command, and thus determines that the interruption occurs.

In the present disclosure, it is assumed that the transmission of the AI model has not been finished yet when the interruption occurs. In other words, part of (but not whole) the AI model has been successfully received by the terminal device 401. The received part of the AI model may include multiple segments.

In some example embodiments, the transmission of the AI model may be segment-wise. For example, the transmitter may transmit the segment with index 1 first, then transmit the segment with index 2, . . . . For the terminal device 401, it may receive consecutive segments or inconsecutive segments. For example, the terminal device 401 may receive segments 1-5. For example, the terminal device 401 may receive segment 1, segment 2, and segment 5, while segments 3 and 4 have not been successfully received yet.

In case part of the AI model has been successfully received by the terminal device 401 when the interruption occurs, the terminal device 401 keeps the part of the AI model at the terminal device 401, at 430. In other words, the terminal device 401 will not delete the received part of the AI model at the time that the interruption occurs. For example, the part of the AI model is buffered in the terminal device 401 for later processing.

In the process flow 400, a procedure for recovery of the interruption is performed at 440. For example, an RRC reestablishment procedure or a handover procedure may be performed.

The terminal device 401 transmits a status message to the first network device 402 at 450. In some example embodiments, if a previous reception (at 410) of the AI model is from the first network device 402 and the first network device 402 is still be communicated with the terminal device 401, then the status message is transmitted to the first network device 402. In some other example embodiments, if a previous reception (at 410) of the AI model is from the second network device 403 but the second network device 403 is not be communicated with the terminal device 401 after a recovery of the interruption, then the status message is transmitted to the first network device 402, for example, the terminal device 401 is handed over from the second network device 403 to the first network device 402.

The status message may indicate the part of the AI model that the terminal device 401 has been successfully received and kept at the terminal device 401. In some examples, the status message may include an ID of the AI model and an index of a segment, where the index of the segment may be (1) a largest index of segments in the part of the AI model that has been successfully received, or (2) a smallest index of segments have not been successfully received.

In some examples, the index of the segment in the status message may include a largest index of consecutive segments that have been successfully received. For example, if segments 1-5 have been successfully received, the index of the segment in the status message may be 5. For example, if segments 1-3 and 5 have been successfully received, the index of the segment in the status message may be 3.

In some other examples, the index of the segment in the status message may include a smallest index of segments that have not been successfully received. For example, if segments 1-5 have been successfully received, the index of the segment in the status message may be 6. For example, if segments 1-3 and 5 have been successfully received, the index of the segment in the status message may be 4.

Alternatively, the status message may further include one or more indexes of inconsecutive segments that have been successfully received. For example, if segments 1-3 and 5 have been successfully received, then the status message may further include an index 5 to indicate a segment which has been successfully received but is not consecutive with other segments.

Alternatively, the status message may further include one or more indexes of segments that have not been successfully received. For example, if segments 1-3 and 5 have been successfully received, and the total number of segments is 7, then the status message may further include indexes 4, 6, and 7 to indicate segments that have not been successfully received.

As such, the status message may be transmitted to the first network device 402 to indicate the part of the AI model which has been successfully received and kept (buffered) at the terminal device 401. In some examples, the terminal device 401 may expect the first network device 402 to transmit the remaining part of the AI model, rather than the whole AI model.

On the other side of communication, the first network device 402 receives the status message, and accordingly, the first network device 402 may be aware of the previous transmission status of the AI model.

In some example embodiments, the first network device 402 may determine to continue transmitting the remaining part of the AI model. As shown in FIG. 4, the first network device 402 transmits the remaining part of the AI model to the terminal device 401 at 460. In some examples, the remaining part of the AI model may include at least one segment, where the smallest index of the at least one segment may be determined based on the status message. For example, if the index of segment in the status message is X (e.g., a largest index of segments that have been successfully received), then the smallest index of the at least one segment may be X+1. For example, if the index of segment in the status message is X (e.g., a smallest index of segments that have not been successfully received), then the smallest index of the at least one segment may be X.

According to some embodiments described above, a remaining part of the AI model may be transmitted after a recovery of an interruption. There may be no need to retransmit the whole AI model, and thus the transmission efficiency may be improved.

In addition or alternatively, there may be not the AI model stored locally at the first network device 402. For example, the terminal device 401 was receiving the AI model from the second network device 403 at 410. In some example embodiments, the second network device 403 may transmit at least the remaining part of the AI model to the first network device 402 at 445.

Each of the first network device 402 and the second network device 403 may be an access network device, such as a gNB. In case the interruption includes an RLF, the first network device 402 may inform the second network device 403 about an access of the terminal device 401 and also ask for the AI model. In case the interruption includes a handover, the first network device 402 may request for the AI model together with or separately from a handover request acknowledge.

In some examples, the second network device 403 may transmit the remaining part of the AI model to the first network device 402, and the first network device 402 may further segment the remaining part of the AI model into at least one segment. Alternatively, the first network device 402 may also transmit information of the remaining part of the AI model to the terminal device 401 at 460, where the information of the remaining part of the AI model is associated with the segmentation by the first network device 402.

In some other examples, the second network device 403 may transmit the whole AI model and the information of the AI model to the first network device 402. Accordingly, the first network device 402 may determine the remaining part of the AI model based on the information of the AI model and the status message. As one example, the first network device 402 may transmit the remaining part of the AI model which has been segmented by the second network device 403. As another example, the first network device 402 may re-segment the remaining part of the AI model.

In some example embodiments, the terminal device 401 may start a timer upon a detection of the interruption (at 420) during the reception of the AI model. In some examples, the timer may be a specific timer for the AI model, such as a new timer. In some other examples, the timer may be an existing timer, such as T300 or T304. The timer may be a model handling timer, which represents a time period for the terminal device 401 to decide whether to delete the received part of the AI model. In some examples, a time limit of the timer may be a value included in the information of the AI model.

Alternatively, upon an expiry of the timer, the terminal device 401 may delete the part of the AI model which has been successfully received and kept (at 430) at the terminal device 401. For example, if a processing time for a recovery of the interruption is too long, i.e., longer than the time limit of the timer, the terminal device 401 may delete the part of the AI model which has been successfully received and kept at the terminal device 401. For example, if no further instruction or segment is received before the expiry of the timer, the terminal device 401 may delete the part of the AI model which has been successfully received and kept at the terminal device 401.

In some examples, in case the part of the AI model has been deleted before the step 450, the transmission of the status message may be omitted, or the status message may include the ID of the model and a predefined value, where the predefined value may indicate that the part of the AI model has been deleted due to an expiry of the timer. For example, the predefined value may be 0 or a value larger than the total number of segments.

In some other examples, in case the part of the AI model has been deleted after the step 450 but no remaining part of the AI model has been received (i.e., before step 460), the terminal device 401 may transmit a delete indication to the first network device 402, where the delete indication may indicate that the part of the AI model has been deleted due to an expiry of the timer.

In some other example embodiments, the first network device 402 may decide not to transmit the remaining part of the AI model. In some examples, the first network device 402 may check the model application condition, for example, if the AI model is not fit anymore. For example, the first network device 402 may transmit an indication to the terminal device 401, where the indication may indicate the terminal device 401 to delete the kept part of the AI model, or the indication may indicate that the AI model is not applied (or fit) any more. For example, the indication may be an explicit command for deleting the part of the AI model. For another example, the first network device 402 may do nothing, i.e., not transmit the remaining part or the indication. So that the timer at the terminal device 401 may expire later.

In some other example embodiments, the first network device 402 may decide to retransmit the whole AI model. In some examples, if a ratio of the already transmitted part of the AI model to the whole AI model is not larger than or is smaller than a threshold (such as 20%, 15%, or another value), the first network device 402 may decide to retransmit the whole AI model. In some examples, the first network device 402 may transmit the AI model from a segment with index 1. In some examples, the first network device 402 may retransmit the AI model without waiting for the status message from the terminal device 401.

The terminal device 401 may receive the retransmitted AI model, for example, the terminal device 401 may receive at least one segment started from index 1. Accordingly, the terminal device 401 may be aware that the retransmission has been initiated, and the kept part of AI model can be deleted.

In some embodiments, the timer at the terminal device 401 may be stopped upon a transmission associated with the AI model is received from the first network device 402, for example, a remaining part of the AI model at 460, an indication that indicates to delete the received part of the AI model, or the retransmitted AI model started from index 1.

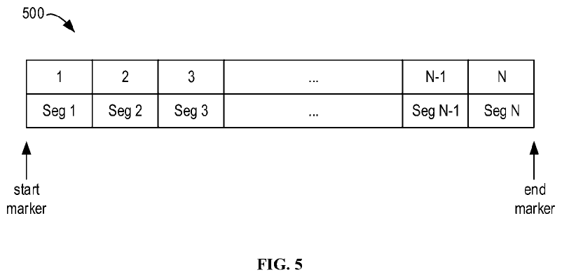

It is to be understood that the embodiments with reference to FIG. 4 are only for the purpose of illustration without any limitation of the present disclosure. Some detailed embodiments may refer to FIGS. 5-8B below.

FIG. 5 illustrates an example of a segmentation 500 of an AI model in accordance with some example embodiments of the present disclosure. An AI model may be segmented into N segments with indexes 1~N, that is, the total number of segments is N where N is a positive integer. Additionally, at least one of the start marker and the end marker may be indicated to the terminal device, so that the terminal device may be aware of whether the AI model has been received completely. For example, the start marker may be used to identify a start position of the first segment (i.e., Seg 1), or the start marker may be an identifier before the first segment. For example, the end marker may be used to identify an end position of the last segment (i.e., Seg N), or the end marker may be an identifier after the last segment.

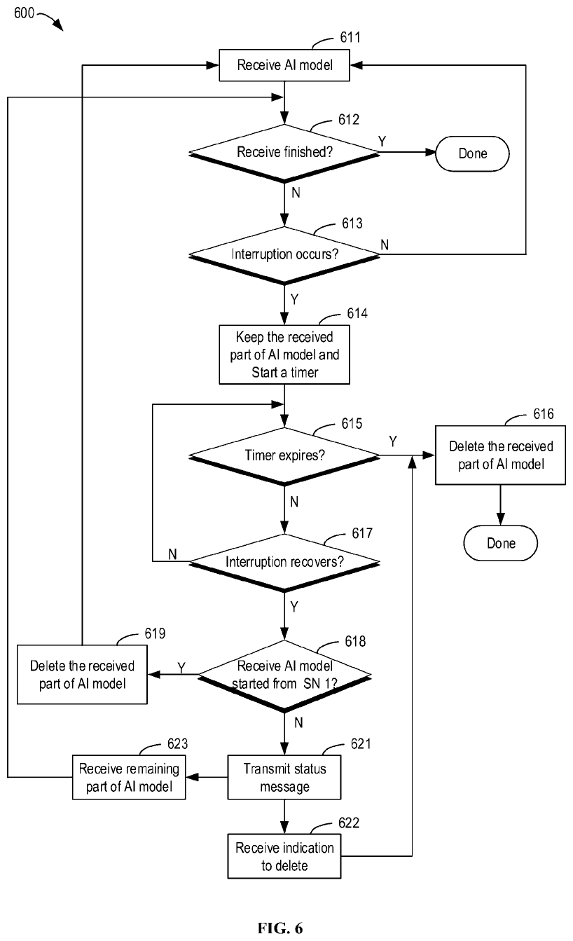

FIG. 6 illustrates an example of process 600 at a terminal device in accordance with some example embodiments of the present disclosure. It is assumed that the AI model has been divided into multiple segments, and the terminal device is receiving the AI model at 611.

The terminal device may determine whether the AI model has been completely received at 612. For example, an end marker may be used to judge whether the AI model is completely received. If so, then the reception of the AI model may be finished.

If the AI model has not been completely received, that is, during a reception of the AI model, an interruption may occur at 613. If it is determined that an interruption occurs at 613, the terminal device may keep the received part of the AI model and start a timer at 614.

In case the timer expires at 615, the terminal device may delete the kept part of the AI model at 616, and accordingly, the reception of the AI model may be terminated. In case the timer has not expired, further operation(s) may be performed after a recovery of the interruption at 617.

At 618, the terminal device may determine whether receive a retransmitted AI model, such as at least one segment started from SN (or index) 1. If so, the terminal device may be aware that the network device decides to retransmit the AI model, and accordingly, the timer may be stopped and the received part of AI model may be deleted at 619. Additionally, the terminal device receives the whole AI model from the beginning, such as from the step 611.

If no retransmitted AI model is received at 618, the terminal device may transmit a status message at 621 to indicate the received part of AI model.

Alternatively, the terminal device may receive an indication at 622 to indicate the terminal device to delete the received part of the AI model, and the step 616 may be further performed based on the indication. For example, the indication may indicate that the AI model is not applicable or fit for the terminal device any more. For example, the terminal device may stop the timer upon a reception of the indication at 622.

Alternatively, the terminal device may receive the remaining part of the AI model at 623, and the process may be forwarded back to step 612. For example, the terminal device may stop the timer upon a reception of the remaining part at 623.

It is to be understood that the embodiments with reference to FIG. 6 are only for the purpose of illustration without any limitation of the present disclosure. In some examples, whether the time expires may be checked before 618, 622, or 623. In some examples, the step 618 may be performed after 621. In some examples, the timer may be stopped at 622 or 623. In some examples, the terminal device may receive the AI model including segments started from index 1 after 616. In some examples, the terminal device may transmit a status message including a default value to the network device if it is determined that the timer expires at 615. In some examples, if the interruption is not recovered, e.g., an RRC reestablishment is not successful and falls back to an RRC establishment, the terminal device may delete the part of the AI model. The present disclosure will not list for brevity.

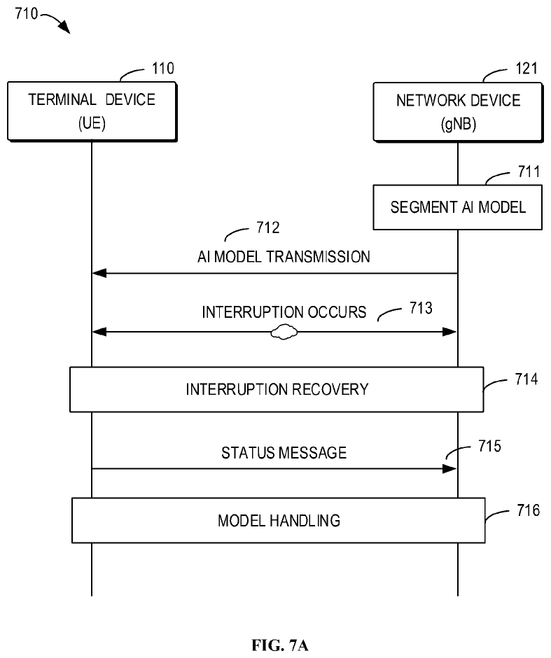

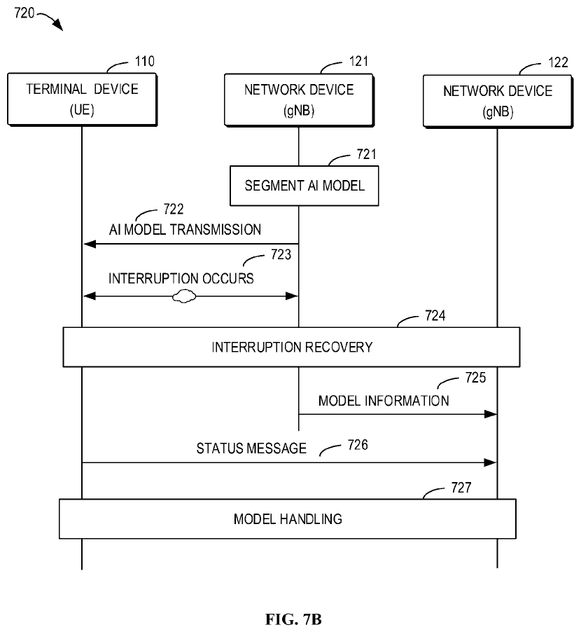

FIG. 7A illustrates an example of a process flow 710 in accordance with some example embodiments of the present disclosure. The process flow 710 involves the terminal device 110 and the network device 121 as shown in FIG. 1. For example, the terminal device 110 may be a UE and the network device 121 may be a gNB. While with reference to FIG. 4, the terminal device 110 may be the terminal device 401 and the network device 121 may be the first network device 402 in FIG. 4.

At 711, the network device 121 segments an AI model into multiple segments. In some example embodiments, the network device 121 may determine model related information. In some examples, the model related information may include a model ID, a start marker, an end marker, and a model length. For example, the model length may be a total number of the segments, such as N. In some examples, the model related information may include a value for a timer, and the value may indicate a time limit of the timer.

At 712, the network device 121 starts a transmission of the AI model to the terminal device 110. In some example embodiments, the AI model may be transferred by one or more RRC messages via signaling radio bearer (SRB). In some example embodiments, the AI model may be transferred as data packages via data radio bearer (DRB).

In some example embodiments, the model related information may be transmitted together with the first segment among the multiple segments of the AI model. In some other example embodiments, the model related information may be transmitted independent from the multiple segments, for example, the model related information may be transmitted in a separate message before the first segment. It is to be appreciated that the model related information may be used by the terminal device 110 to determine how much of the AI model has been successfully received and whether the AI model is completely received.

In some examples, the multiple segments may be transmitted sequentially. Each segment may be transmitted together with the model ID and a corresponding index (i.e., SN).

At 713, an interruption occurs. And the interruption may be recovered at 714. In some examples, the interruption may be an RLF or a handover, a recovery procedure may refer to FIG. 2A or FIG. 3A respectively. For example, if the current link is damaged, the on-going AI model transfer may be interrupted, after the link failure is fixed and an RRC reestablishment is finished, the terminal device 110 may reestablish to a new cell within the network device 121. For example, the terminal device 110 may receive a handover command from the network device 121, the terminal device 110 will detach from a current cell, after the handover is finished and the random access for the terminal device 110 is successfully completed, the terminal device 110 may connect to a new cell within the network device 121.

In the present disclosure, the AI model has not been completely received when the interruption occurs at 713, and the terminal device 110 may buffer the received part of the AI model rather than deleting immediately.

In addition or alternatively, the terminal device 110 may start a timer upon the interruption occurs. For example, the terminal device 110 may start the timer when the RLF is detected. For example, the terminal device 110 may start the timer once the handover command is received (or detected).

At 715, the terminal device 110 transmits a status message to the network device 121. The status message may be transmitted via an RRC signalling to share the buffered model status at the terminal device 110 side. For example, the status message may include the model ID and an index (which is a largest SN the terminal device 110 has already received, or a smallest SN the terminal device 110 expects to receive). By doing this, the network device 121 may be able to know which AI model and how much of the AI model has been successfully received based on the status message. In other words, the status message may help the network device 121 to pinpoint the exact place to start transmitting of the remaining part of the AI model.

In some example embodiments, the status message may be carried in a message during a recovery of the interruption, for example, the status message may be included in an RRC reestablishment request message. In some other example embodiments, the status message may be carried in another RRC message after the recovery of the interruption.

As mentioned above, a timer may be started upon a detection of the interruption. In some embodiments, if the timer expires, the terminal device 110 may delete the received part of AI model. Alternatively, the status message at 715 may include the model ID and a predefined value (default index) to indicate that the received part of the AI model has been deleted due to an expiry of the timer.

In some examples, if the received part of the AI model has been deleted by the terminal device 110 due to an expiry of the timer, the status message may be omitted, i.e., not transmitted. In other words, the terminal device 110 may feedback no ID or default index to the network device 121. In some other examples, if the received part of the AI model has been deleted by the terminal device 110 due to an expiry of the timer, the status message may include the model ID and the default index. In other words, the terminal device 110 may feedback explicitly through the model ID and the default index.

At 716, the model handling may be further performed. In some example embodiments, the network device 121 may check the model application condition after receiving the status message.

In some example embodiments, if the AI model still fits the new cell, the network device 121 may check the information in the status message. For example, the network device 121 may be aware of the current AI model transfer process.

In some examples, if the AI model is still buffered at the terminal device 110, the network device 121 may continue transmitting the remaining part of the AI model based on the status message. For example, the smallest index of segment in the remaining part of the AI model is determined based on the index in the status message.

In some other examples, if the received part of AI model has been deleted due to an expiry of the timer, the network device 121 may directly retransmit the whole AI model, e.g., from the beginning of the AI model, such as segment 1.

In some other examples, if a retransmission is triggered, the network device 121 may directly retransmit the whole AI model, e.g., from the beginning of the AI model, such as segment 1, without waiting for the status message from the terminal device 110. For example, if a ratio of the already transmitted part of the AI model to the whole AI model is not larger than or is smaller than a threshold (such as 20%), the retransmission is triggered. In the present disclosure, the retransmission is triggered may also be referred to as the retransmission (or retransfer) trigger is on.

In some other example embodiments, if the AI model does not fit the new cell (or the new area or the new frequency), the network device 121 may transmit an indication to the terminal device 110, to ask the terminal device 110 to delete the received part of the AI model. In some examples, the network device 121 may transmit another AI model with another model ID to the terminal device 110, with a similar procedure described above.

As such, according to some handing procedures in some embodiments, the interrupted AI model transfer is restored, and the remaining part of the AI model can be efficiently and effectively transferred from the network device 121 to the terminal device 110.

FIG. 7B illustrates an example of a process flow 720 in accordance with some example embodiments of the present disclosure. The process flow 720 involves the terminal device 110, the network device 121, and the network device 122 as shown in FIG. 1. For example, the terminal device 110 may be a UE and the network device 121/122 may be a gNB. While with reference to FIG. 4, the terminal device 110 may be the terminal device 401, the network device 121 may be the second network device 403, and the network device 122 may be the first network device 402 in FIG. 4.

At 721, the network device 121 segments an AI model into multiple segments. At 722, the network device 121 starts a transmission of the AI model to the terminal device 110. At 723, an interruption occurs. The steps 721-723 are similar to steps 711-713 in FIG. 7A respectively, and thus will not be repeated herein.

The interruption may be recovered at 724. In some examples, the interruption may be an RLF or a handover, a recovery procedure may refer to FIG. 2B or FIG. 3B respectively. For example, if the current link is damaged, the on-going AI model transfer may be interrupted, after the link failure is fixed and an RRC reestablishment is finished, the terminal device 110 may reestablish to a new cell of a new gNB, i.e., the network device 122. For example, the terminal device 110 may receive a handover command from the network device 121, the terminal device 110 will detach from a current cell and the on-going AI model transfer is interrupted, after the handover is finished and the random access for the terminal device 110 is successfully completed, the terminal device 110 may hand over and connect to a new cell of a new (or target) gNB, i.e., the network device 122.

In the present disclosure, the AI model has not been completely received when the interruption occurs at 723, and the terminal device 110 may buffer the received part of the AI model rather than deleting immediately.

In addition or alternatively, the terminal device 110 may start a timer upon the interruption occurs. For example, the terminal device 110 may start the timer when the RLF is detected. For example, the terminal device 110 may start the timer once the handover command is received (or detected).

At 725, the network device 121 transmits at least the remaining part of the AI model to the network device 122.

In some example embodiments, after a recovery of the RLF, the network device 122 may inform the network device 121 (may refer to 224 in FIG. 2B) about the terminal device 110's access, additionally, the network device 122 may ask the network device 121 to provide the AI model if the network device 122 does not have the information of the AI model. In some examples, if the network device 122 has the AI model, there is no need for asking from the network device 121.

For example, the network device 122 may obtain the whole AI model from the network device 121. It is noted that the network device 122 obtains the whole AI model so that the AI model can be aligned between the network device 122 and the terminal device 110, e.g., the network device 122 may determine the remaining part of the AI model precisely based on the status message received at 726.

In some other example embodiments, during the procedure of the handover, the network device 121 may inform the network device 122 that an AI model transfer is on-going. In some examples, the network device 121 may inform the network device 122 of the on-going AI model transfer at the terminal device 110 so that the network device 122 may be aware of the transfer process, e.g., the inform may be performed along with the handover request to the network device 122 (may refer to 323 in FIG. 3B). By doing this, the network device 122 will in turn know that there was an AI model transfer process going on from the network device 121 to the terminal device 110 before handover.

In some examples, if the network device 122 does not have the information of the AI model, it may ask the network device 121 to provide the AI model. For example, a request may be transmitted from the network device 122 to the network device 121, e.g., the request may be carried (or indicated) in a handover request acknowledge message (may refer to 324 in FIG. 3B) or may be in a separate signalling.

In some example embodiments, the network device 121 may transmit a payload of the AI model and the model related information to the network device 122, e.g., via the Xn interface, at 725. In some examples, the payload of the AI model may be the whole AI model, all segments of the AI model determined by the network device 121, or the segments of the remaining part of the AI model.

For example, the whole AI model (i.e., a complete AI model) without segmentation may be delivered to the network device 122. In some examples, the network device 122 may further segment the AI model and may transfer from beginning, e.g., may apply to the case when the AI model needs to be transferred from the beginning once again.

For example, all segments of the AI model that has been generated by the network device 121 may be delivered to the network device 122. For example, only the segments of the AI model that has not been transmitted to the terminal device 110 may be delivered to the network device 122. It is noted that the segmentation details (i.e., segmenting standard, the length of each segment, and how many segments are there) need to be shared to the network device 122, so that the network device 122 can align with the network device 121, having the same segmentation setting when continuing transferring the remaining AI model.

At 726, the terminal device 110 transmits a status message to the network device 122. At 727, the model handling may be further performed. The steps 726-727 are similar to steps 715-176 in FIG. 7A respectively, and thus will not be repeated herein.

As such, according to some handing procedures in some embodiments, the interrupted AI model transfer is restored, and the remaining part of the AI model can be efficiently and effectively transferred from the network device 122 to the terminal device 110.

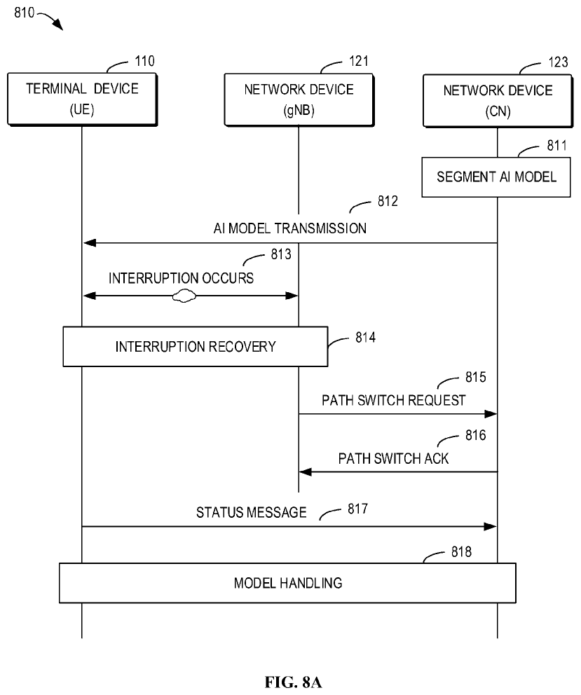

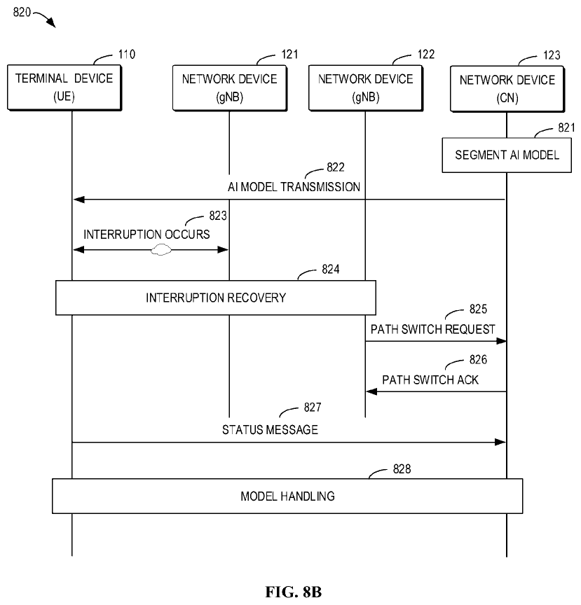

FIG. 8A illustrates an example of a process flow 810 in accordance with some example embodiments of the present disclosure. The process flow 810 involves the terminal device 110, the network device 121, and the network device 123 as shown in FIG. 1. For example, the terminal device 110 may be a UE, the network device 121 may be a gNB, and the network device 123 may be a CN function. While with reference to FIG. 4, the terminal device 110 may be the terminal device 401 and the network device 123 may be the first network device 402 in FIG. 4.

At 811, the network device 123 segments an AI model into multiple segments. In some example embodiments, the network device 123 may determine model related information. In some examples, the model related information may include a model ID, a start marker, an end marker, and a model length. For example, the model length may be a total number of the segments, such as N. In some examples, the model related information may include a value for a timer, and the value may indicate a time limit of the timer.

At 812, the network device 123 starts a transmission of the AI model to the terminal device 110. In some example embodiments, the AI model may be transferred by using one or more NAS or LPP messages.

In some example embodiments, the model related information may be transmitted together with the first segment among the multiple segments of the AI model. In some other example embodiments, the model related information may be transmitted independent from the multiple segments, for example, the model related information may be transmitted in a separate message before the first segment. It is to be appreciated that the model related information may be used by the terminal device 110 to determine how much of the AI model has been successfully received and whether the AI model is completely received.

In some examples, the multiple segments may be transmitted sequentially. Each segment may be transmitted together with the model ID and a corresponding index (i.e., SN).

At 813, an interruption occurs. And the interruption may be recovered at 814. The steps 813-814 are similar to steps 713-714 in FIG. 7A respectively, and thus will not be repeated herein.

At 815, the network device 121 transmits a path switch request to the network device 123. The request may inform the network device 123 about the terminal device 110's connection change, e.g., from a cell to a new cell. At 816, the network device 123 transmits a path switch acknowledge to the network device 121. In some examples, the path switch request and the path switch acknowledge may be transmitted via an NG interface.

At 817, the terminal device 110 transmits a status message to the network device 123. At 818, the model handling may be further performed. The steps 817-818 are similar to steps 715-176 in FIG. 7A respectively, except that the network device 123 is a core network device, and the status message may be transmitted via a NAS or LPP message.

As such, according to some handing procedures in some embodiments, the interrupted AI model transfer is restored, and the remaining part of the AI model can be efficiently and effectively transferred from the network device 123 to the terminal device 110.

FIG. 8B illustrates an example of a process flow 820 in accordance with some example embodiments of the present disclosure. The process flow 820 involves the terminal device 110, the network device 121, the network device 122, and the network device 123 as shown in FIG. 1. For example, the terminal device 110 may be a UE, the network device 121/122 may be a gNB, and the network device 123 may be a CN function. While with reference to FIG. 4, the terminal device 110 may be the terminal device 401 and the network device 123 may be the first network device 402 in FIG. 4.

At 821, the network device 123 segments an AI model into multiple segments. At 822, the network device 123 starts a transmission of the AI model to the terminal device 110. The steps 821-822 are similar to steps 811-812 in FIG. 8A respectively, and thus will not be repeated herein.

At 823, an interruption occurs. And the interruption may be recovered at 824. The steps 823-824 are similar to steps 723-724 in FIG. 7B respectively, and thus will not be repeated herein.

At 825, the network device 122 transmits a path switch request to the network device 123. The request may inform the network device 123 about the terminal device 110's connection change, e.g., from the network device 121 to the network device 122. At 826, the network device 123 transmits a path switch acknowledge to the network device 122. In some examples, the path switch request and the path switch acknowledge may be transmitted via an NG interface.

At 827, the terminal device 110 transmits a status message to the network device 123. At 828, the model handling may be further performed. The steps 827-828 are similar to steps 715-176 in FIG. 7A respectively, except that the network device 123 is a core network device, and the status message may be transmitted via a NAS or LPP message.

As such, according to some handing procedures in some embodiments, the interrupted AI model transfer is restored, and the remaining part of the AI model can be efficiently and effectively transferred from the network device 123 to the terminal device 110.

According to some embodiments discussed with reference to FIGS. 1-8B, a solution for addressing the AI model transfer interruption is proposed. With the aid of model related information and the status message (indicates buffered part of AI model), the first network device is able to flexibly and efficiently transfer the AI model after the interruption is fixed, therefore enabling the case use of the AI model at the terminal device.

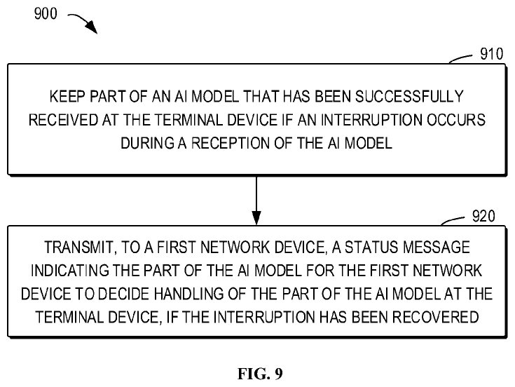

FIG. 9 illustrates a flowchart of an example method 900 for communication in accordance with some embodiments of the present disclosure. In some embodiments, the method 900 can be implemented at a terminal device (such as terminal device 110 or terminal device 401) in a communication network. Further, it is to be understood that the method 900 may include additional blocks not shown and/or may omit some blocks as shown, and the scope of the present disclosure is not limited in this regard.

At block 910, the terminal device keeps part of an AI model that has been successfully received at the terminal device if an interruption occurs during a reception of the AI model. At block 920, if the interruption has been recovered, the terminal device transmits, to a first network device, a status message indicating the part of the AI model for the first network device to decide handling of the part of the AI model at the terminal device.

In some example embodiments, the terminal device receives, from a second network device, one or more messages comprising one or more segments of the AI model.

In some example embodiments, the terminal device receives, from the second network device, information of the AI model comprising an identifier (ID) of the AI model, where the information of the AI model further comprises at least one of: a total number of segments, a start marker, or an end marker. In some examples, the ID of the AI model is used to identify the AI model, and the ID of the AI model is different from a further ID of a further AI model.

In some example embodiments, the terminal device receives message including one or more AI models, each AI model including an ID and information of payload of AI model.

In some example embodiments, the information of the AI model is comprised in the first of the one or more messages.

In some example embodiments, the part of the AI model comprises a plurality of segments of the AI model with a plurality of consecutive or inconsecutive indexes.

In some example embodiments, the status message comprises: an ID of the AI model and an index of a segment, where the index of the segment is a largest index of segments in the part of the AI model or is a smallest index of segments have not been successfully received.

In some example embodiments, the status message further comprises one or more indexes of inconsecutive segments which have been successfully received.

In some example embodiments, the second network device and the first network device are different access network devices or a same access network device, and wherein the status message is carried in radio resource control (RRC) signalling.

In some example embodiments, the first network device and the second network device are a same core network device, and wherein the status message is carried in non-access stratum (NAS) signalling or long term evolution positioning protocol (LPP) signalling.

In some example embodiments, the terminal device receives, from the first network device, a remaining part of the AI model associated with the status message.

In some example embodiments, the remaining part of the AI model is segmented by the first network device.

In some example embodiments, the remaining part of the AI model comprises at least one segment, and wherein the smallest index of the at least one segment equals to an index comprised in the status message or equals to a sum of the index comprised in the status message and one.

In some example embodiments, the terminal device starts a timer upon a detection of the interruption during the reception of the AI model; and deletes the part of the AI model that has been successfully received if the timer expires.

In some example embodiments, a time limit of the timer is a value specific to the AI model or is a value common for multiple AI models. In some example embodiments, the time limit of the timer is comprised in information of the AI model.

In some example embodiments, the status message comprises an ID of the AI model or a predefined value indicating that the part of the AI model has been deleted due to an expiry of the timer.

In some example embodiments, the terminal device receives, from the first network device, an indication indicating that the AI model is not applied at the first network device; and deletes the part of the AI model that has been successfully received based on the indication.

In some example embodiments, the terminal device receives, from the first network device, the AI model comprising segments with indexes started from 1; and deletes the part of the AI model.

In some example embodiments, the interruption comprises a radio link failure (RLF) or a handover.

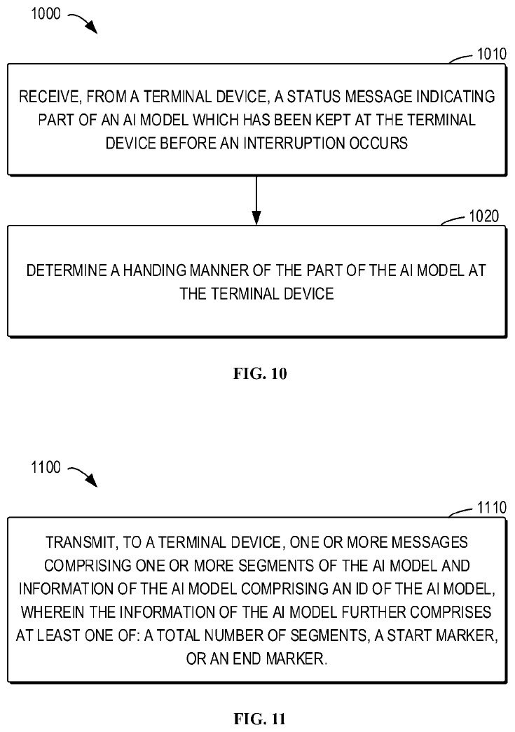

FIG. 10 illustrates a flowchart of an example method 1000 for communication in accordance with some embodiments of the present disclosure. In some embodiments, the method 1000 can be implemented at a first network device (such as the network device 121, 122, or 123, the first network device 402) in a communication network. Further, it is to be understood that the method 1000 may include additional blocks not shown and/or may omit some blocks as shown, and the scope of the present disclosure is not limited in this regard.

At block 1010, the first network device receives, from a terminal device, a status message indicating part of an AI model which has been kept at the terminal device before an interruption occurs. At block 1020, the first network device determines a handing manner of the part of the AI model at the terminal device.

In some example embodiments, the first network device transmits, to the terminal device, one or more messages comprising one or more segments of the AI model.

In some example embodiments, the first network device transmits, to the terminal device, information of the AI model comprising an ID of the AI model, where the information of the AI model further comprises at least one of: a total number of segments, a start marker, or an end marker.

In some example embodiments, the information of the AI model is comprised in the first of the one or more messages.

In some example embodiments, the part of the AI model comprises a plurality of segments of the AI model with a plurality of consecutive or inconsecutive indexes.

In some example embodiments, the status message comprises: an ID of the AI model and an index of a segment, where the index of the segment is a largest index of segments in the part of the AI model or is a smallest index of segments have not been successfully received by the terminal device.

In some example embodiments, the status message further comprises one or more indexes of inconsecutive segments which have been successfully received.

In some example embodiments, the first network device transmits, to the terminal device, a remaining part of the AI model based on the status message.

In some example embodiments, the remaining part of the AI comprises at least one segment, and wherein the smallest index of the at least one segment equals to an index comprised in the status message or equals to a sum of the index comprised in the status message and one.

In some example embodiments, the first network device receives, from a second network device, at least the remaining part of the AI model and information of the AI model comprising an ID of the AI model.

In some example embodiments, the at least one remaining part of the AI model comprises at least one segment segmented by the send network device, and wherein the information of the AI model further comprises at least one of: a number of the at least one segment, a start marker, or an end marker.

In some example embodiments, the first network device determines the remaining part of the AI model based on the status message, the AI model, and the information of the AI model; and segments, the remaining part of the AI model into multiple segments.

In some example embodiments, the first network device is an access network device, and wherein the status message is carried in radio resource control (RRC) signalling.

In some example embodiments, the first network device is a core network device, and wherein the status message is carried in non-access stratum (NAS) signalling or long term evolution positioning protocol (LPP) signalling.

In some example embodiments, the first network device transmits, to the terminal device, an indication indicating that the AI model is not applied at the first network device.

In some example embodiments, the status message comprises an ID of the AI model or a predefined value indicating that the part of the AI model has been deleted due to an expiry of a timer.

In some example embodiments, a time limit of the timer is comprised in information of the AI model. In some example embodiments, the time limit of the timer is a value specific to the AI model or is a value common for multiple AI models.

In some example embodiments, if a ratio of the already transmitted part of the AI model to the whole AI model is not larger than or is smaller than a threshold, the first network device determines to transmit the AI model to the terminal device right after the interruption is recovered without waiting for status message.

In some example embodiments, the interruption comprises a radio link failure (RLF) or a handover.

FIG. 11 illustrates a flowchart of an example method 1100 for communication in accordance with some embodiments of the present disclosure. In some embodiments, the method 1100 can be implemented at a second network device (such as the network device 121 or the second network device 403) in a communication network. Further, it is to be understood that the method 1100 may include additional blocks not shown and/or may omit some blocks as shown, and the scope of the present disclosure is not limited in this regard.

At block 1110, the second network device transmits, to a terminal device, one or more messages comprising one or more segments of the AI model and information of the AI model comprising an ID of the AI model, wherein the information of the AI model further comprises at least one of: a total number of segments, a start marker, or an end marker.

In some example embodiments, the information of the AI model is comprised in the first of the one or more messages.

In some example embodiments, the second network device transmits, to a first network device, at least a remaining part of the AI model and the information of the AI model, where the second network device is an access network device of the terminal device before an interruption occurs during a reception of the AI model, and the first network device is another access network device of the terminal device after the interruption recovers.

In some example embodiments, the at least one remaining part of the AI model comprises at least one segment segmented by the send network device.

In some example embodiments, the interruption comprises a radio link failure (RLF) or a handover.

In some example embodiments, the information of the AI model further comprises a time limit of a timer being used by the terminal device to delete the part of the AI model when the timer with the time limit expires.

In some example embodiments, the time limit of the timer is a value specific to the AI model or is a value common for multiple AI models.

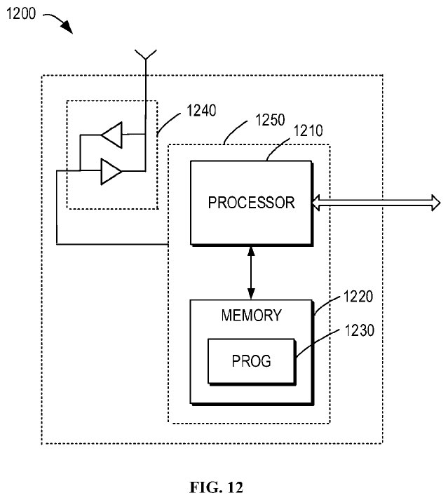

FIG. 12 illustrates a simplified block diagram of an apparatus 1200 (also termed as a device 1200) that is suitable for implementing embodiments of the present disclosure.

The apparatus 1200 can be considered as a further example implementation of the terminal device and the network device as described above, such as terminal device 110 and the network devices 121-123 as shown in FIG. 1, or the terminal device 401, the first network device 402, and the second network device 403 as shown in FIG. 4. Accordingly, the apparatus 1200 can be implemented at or as at least a part of the terminal device and the network device.

As shown, the apparatus 1200 includes a processor 1210, a memory 1220 coupled to the processor 1210, a suitable transmitter (TX) and receiver (RX) 1240 coupled to the processor 1210, and a communication interface coupled to the TX/RX 1240. The memory 1220 stores at least a part of a program 1230. The TX/RX 1240 is for bidirectional communications. The TX/RX 1240 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), Uu interface for communication between the eNB and a terminal device, or PC5 interface for communication between two terminal devices.

The program 1230 is assumed to include program instructions that, when executed by the associated processor 1210, enable the apparatus 1200 to operate in accordance with the embodiments of the present disclosure, as discussed herein. The embodiments herein may be implemented by computer software executable by the processor 1210 of the apparatus 1200, or by hardware, or by a combination of software and hardware. The processor 1210 may be configured to implement various embodiments of the present disclosure. Furthermore, a combination of the processor 1210 and memory 1220 may form processing means 1250 adapted to implement various embodiments of the present disclosure.

The memory 1220 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1220 is shown in the apparatus 1200, there may be several physically distinct memory modules in the apparatus 1200. The processor 1210 may be of any type suitable to the local technical network, and may include one or more of general purpose computers, special purpose computers, microprocessors, digital signal processors (DSPs) and processors based on multicore processor architecture, as non-limiting examples. The apparatus 1200 may have multiple processors, such as an application specific integrated circuit chip that is slaved in time to a clock which synchronizes the main processor.

In some embodiments, an apparatus (for example, the terminal device) capable of performing the method 900 may comprise means for performing the respective steps of the method 900. The means may be implemented in any suitable form. For example, the means may be implemented in a circuitry or software module. In some embodiments, the means comprises at least one processor and at least one memory including computer program code, the at least one memory and computer program code configured to, with the at least one processor, cause the performance of the method 900.

In some embodiments, the apparatus comprises: means for based on a determination that an interruption occurs during a reception of an artificial intelligence (AI) model, keeping part of the AI model that has been successfully received at the terminal device; and means for based on a determination that the interruption has been recovered, transmitting, to a first network device, a status message indicating the part of the AI model for the first network device to decide handling of the part of the AI model at the terminal device.

In some embodiments, an apparatus (for example, the first network device) capable of performing the method 1000 may comprise means for performing the respective steps of the method 1000. The means may be implemented in any suitable form. For example, the means may be implemented in a circuitry or software module. In some embodiments, the means comprises at least one processor and at least one memory including computer program code, the at least one memory and computer program code configured to, with the at least one processor, cause the performance of the method 1000.

In some embodiments, the apparatus comprises: means for receiving, from a terminal device, a status message indicating part of an AI model which has been kept at the terminal device before an interruption occurs; and means for determining a handing manner of the part of the AI model at the terminal device.

In some embodiments, an apparatus (for example, the second network device) capable of performing the method 1100 may comprise means for performing the respective steps of the method 1100. The means may be implemented in any suitable form. For example, the means may be implemented in a circuitry or software module. In some embodiments, the means comprises at least one processor and at least one memory including computer program code, the at least one memory and computer program code configured to, with the at least one processor, cause the performance of the method 1100.

In some embodiments, the apparatus comprises: means for transmitting, to a terminal device, one or more messages comprising one or more segments of an AI model and information of the AI model comprising an ID of the AI model, wherein the information of the AI model further comprises at least one of: a total number of segments, a start marker, or an end marker.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device for wireless communication, comprising:
at least one memory; and
at least one processor coupled with the at least one memory and configured to cause the terminal device to:
based at least in part on a determination that an interruption occurs during a reception of an artificial intelligence (AI) model, keep a part of the AI model that has been successfully received at the terminal device; and
based at least in part on a determination that the interruption has been recovered, transmit a status message indicating the part of the AI model for a first network device to decide handling of the part of the AI model at the terminal device.

2. The terminal device of claim 1, wherein the at least one processor is further configured to cause the terminal device to:
receive one or more messages comprising one or more segments of the AI model.

3. The terminal device of claim 2, wherein the at least one processor is further configured to cause the terminal device to:
receive information of the AI model comprising an identifier (ID) of the AI model,
wherein the information of the AI model further comprises at least one of: a total number of segments, a start marker, or an end marker.

4. The terminal device of claim 3, wherein the information of the AI model is comprised in the first of the one or more messages.

5. The terminal device of claim 2, wherein the status message comprises: an identifier (ID) of the AI model and an index of a segment,
wherein the index of the segment is a largest index of segments in the part of the AI model or is a smallest index of segments that have not been successfully received.

6. The terminal device of claim 5, wherein the status message further comprises one or more indexes of inconsecutive segments which have been successfully received.

7. The terminal device of claim 1, wherein the at least one processor is further configured to cause the terminal device to:
receive a remaining part of the AI model associated with the status message.

8. The terminal device of claim 7, wherein the remaining part of the AI model is segmented by the first network device.

9. The terminal device of claim 8, wherein the remaining part of the AI model comprises at least one segment, and wherein a smallest index of the at least one segment equals to an index comprised in the status message or equals to a sum of the index comprised in the status message and one.

10. The terminal device of claim 1, wherein the at least one processor is further configured to cause the terminal device to:
start a timer upon a detection of the interruption during the reception of the AI model; and
based at least in part on a determination that the timer expires, delete the part of the AI model that has been successfully received.

11. The terminal device of claim 10, wherein a time limit of the timer is comprised in information of the AI model.

12. The terminal device of claim 10, wherein the status message comprises an identifier (ID) of the AI model or a predefined value indicating that the part of the AI model has been deleted due to an expiry of the timer.

13. The terminal device of claim 1, wherein the at least one processor is further configured to cause the terminal device to:
receive the AI model comprising segments with indexes started from 1; and
delete the part of the AI model.

14. A first network device for wireless communication, comprising:
at least one memory; and
at least one processor coupled with the at least one memory and configured to cause the first network device to:
receive a status message indicating part of an artificial intelligence (AI) model which has been kept at a terminal device before an interruption occurs; and
determine a handing manner of the part of the AI model at the terminal device.

15. A second network device for wireless communication, comprising:
at least one memory; and
at least one processor coupled with the at least one memory and configured to cause the second network device to:
transmit one or more messages comprising one or more segments of an artificial intelligence (AI) model and information of the AI model comprising an identifier (ID) of the AI model, wherein the information of the AI model further comprises at least one of: a total number of segments, a start marker, or an end marker.

16. A method performed by a terminal device, the method comprising:
based at least in part on a determination that an interruption occurs during a reception of an artificial intelligence (AI) model, keeping a part of the AI model that has been successfully received at the terminal device; and
based at least in part on a determination that the interruption has been recovered, transmitting a status message indicating the part of the AI model for a first network device to decide handling of the part of the AI model at the terminal device.

17. The method of claim 16, further comprising:
receiving one or more messages comprising one or more segments of the AI model.

18. The method of claim 16, further comprising:
receiving a remaining part of the AI model associated with the status message.

19. The method of claim 16, further comprising:
starting a timer upon a detection of the interruption during the reception of the AI model; and
based at least in part on a determination that the timer expires, deleting the part of the AI model that has been successfully received.

20. The method of claim 16, further comprising
receiving the AI model comprising segments with indexes started from 1; and
deleting the part of the AI model.
